(19) United States
(12) Patent Application Publication
(10) Pub. No.: US 2006/0189375 A1
(43) Pub. Date: Aug. 24, 2006

(54) Method for playing keno with player option for additional drawn numbers

(75) Inventor: Clifford B. Dodge, Billings, MT (US)

Correspondence Address: JOSEPH E. FUNK, 82 CHASE RD, LONDONDERRY, NH, 03053, US

(73) Assignee: Summit Amusement and Distributing, Ltd.

(21) Appl. No.: 11/061,230

(22) Filed: Feb. 18, 2005

(51) Int. Cl. G06F 19/00

(52) U.S. Cl. 463/18

(57) ABSTRACT

A novel Nudge Keno game is disclosed wherein a player selects up to ten numbers from a field of numbers 1-80 to be played and these numbers are compared to twenty numbers randomly selected by the game from the same field of numbers in a manner known in the prior art. When there are at least four number matches the player has winnings. With the invention five additional nudge numbers are randomly selected at the same time as the twenty numbers and are compared to the randomly selected twenty numbers. When there are a predetermined number of nudge number matches the player receives a number of options equal to the number of nudge number matches to have additional random numbers added to the twenty numbers. These additional numbers are also compared to the player selected numbers and increase the player's chances of winning. When the player receives nudge options, whether or not they achieve additional matches between the additional numbers and the player selected numbers, their winnings are determined from a different pay table that provides higher winnings.

### FIELD OF THE INVENTION

This invention generally relates generally to video gaming machines and more particularly to an interactive keno-style game.

### BACKGROUND OF THE INVENTION

Conventional Keno is a well known game. There are eighty numbers in a pool—typically-eighty keno balls numbered 1 through 80 and maintained in an air blower device that circulates the Keno balls. Twenty of the eighty Keno balls are selected each round of game play.

Each player has a Keno ticket that is an 8×10 matrix with the eighty numbers printed thereon. Each player marks their ticket with between one and fifteen of the eighty numbers that the player thinks will be drawn during the game. The player also makes an appropriate wager. Depending on the number of matches between the twenty numbers drawn and the numbers selected and marked by the player on their play card, the player wins or loses. The more matching numbers there are the higher the payoff to the player.

In electronic Keno, a single player plays against a computer controlled video gaming machine for each round of game play and the player either wins or loses each round. No other players are involved. At the beginning of game play the player selects between one and ten numbers and wagers one or more coins, tokens or credits. The computer of the video gaming machine randomly selects twenty numbers from a pool of eighty numbers and then compares the twenty numbers to the player selected numbers to determine if the player has achieved a winning payout for the round of game play. The player selections are made by using a light pen, pressing numbered buttons on a selection panel, or by touching numbers displayed on-screen using conventional video touch screen technology.

In the typical video Keno format, the player may select between one and ten numbers to attempt to match the randomly selected numbers. When the player presses a “Start” button, the computer of the video gaming machine randomly selects twenty numbers from the total pool of eighty numbers, just as in live Keno, the player has winnings based on how many of their selected numbers match the randomly selected twenty numbers. The player's winnings are greater as there are more matches. If the player matches less than the predetermined minimum number of selected numbers, the player loses.

Keno games, alike other wagering games are more successful, when players are provided with a sense of participation and control, the opportunity to make decisions, reasonable odds of winning, and what the players perceive is an improved chance to beat the odds that are normally in favor of a casino or game owner.

Over time gaming patrons become bored with standard versions of games, including Keno, and game owners are continually looking for new variations of the games to create renewed interest and to attract more players to play the games.

It would therefore be advantageous to have a new Keno game which is similar to conventional Keno games but which provides for greater player interaction with the game, and which would appear to provide greater opportunities for winning. Such a new Keno game would stimulate renewed interest of experienced players, and the interest of casual players, who will experience new excitement with the new interactive Keno game.

### SUMMARY OF THE INVENTION

The present invention combines the most desirable elements of conventional Keno games with a novel improvement that gives a player more sense of participation and control, the opportunity to make decisions, reasonable odds of winning, and what the players perceive is a chance to beat odds that are normally in favor of a game owner. The result is a novel “Nudge Keno” game.

The novel improvement is added to a standard computer controlled video Keno game where a player initially selects between two and ten numbers to play from a pool of eighty numbers in manner well known in the Keno art by touching between two and ten of the eighty numbers displayed on a video screen equipped with touch screen technology. All eighty numbers are displayed in an 8×10 matrix and the player selected play numbers are highlighted in some manner in the matrix as in the prior art. The player also places a wager as in the prior art.

Upon the player touching a Start button the game computer randomly selects and displays twenty numbers from the pool of eighty numbers in a manner known in the Keno art. The twenty numbers are displayed adjacent to the 8×10 matrix. The number of matches between the player selected numbers and the twenty numbers randomly selected by the game computer determines the player's winnings.

In accordance with the teaching of the present invention, at the time game computer randomly selects the twenty numbers from the eighty numbers the computer also randomly selects five additional “nudge numbers”, each of which is associated with a letter in the word “Nudge”. Each of the letters of the word “Nudge” are displayed in the 8×10 matrix in the position of their corresponding randomly selected nudge number. If there are no matches between a predetermined quantity of the five additional “Nudge” numbers and the twenty numbers randomly selected by the game computer there can be no chance to achieve any additional winnings due to the novel Nudge feature and any game winnings are based solely upon the number of matches between the player selected numbers and the twenty numbers randomly selected by the computer as in the prior art.

If, however, there are matches between at least a predetermined number of the five additional nudge numbers and the twenty randomly selected numbers, the player receives up to five options to “nudge” the display of the randomly drawn twenty numbers to thereby display additional numbers that may yield additional matches with the player selected numbers and thereby increase the player's winnings. For example, if there are three matches between the five randomly selected nudge numbers and the twenty numbers randomly selected for play, the player receives three options to “nudge” the display of the randomly drawn twenty numbers to thereby display three additional numbers that may yield additional matches with the numbers initially selected by the player to be played. This increases the player's chances of winning at the Keno game. When the player receives nudge options, whether or not they achieve additional matches between the additional numbers and the player selected numbers, their winnings are determined from a different pay table that provides higher winnings.

### DESCRIPTION OF THE DRAWINGS

The invention will be better understood upon reading the following Detailed Description in conjunction with the drawing in which:

FIG. 1 shows the display screen of a video Keno game having additional display elements for implementing the novel “Nudge Keno” game;

FIG. 2 shows the display screen of FIG. 1 with ten numbers selected by a player to be played in the Nudge Keno game, and these ten numbers are used in all examples of the Nudge Keno game described in the Detailed Description;

FIG. 3 shows a first example of the Nudge Keno game wherein the player receives winnings due to a minimum number of matches between the ten player selected numbers and the twenty numbers randomly selected by the game computer in a conventional manner, but there are no matches between the five additional nudge numbers randomly selected by the computer and the twenty numbers;

FIG. 4 shows a second example of the Nudge Keno game wherein the player receives no winnings because there is no minimum match between the ten player selected numbers and the twenty numbers randomly selected by the game computer, although there is a match between some of the five additional nudge numbers randomly selected by the game computer and the twenty numbers randomly selected by the game computer;

FIG. 5 shows the first step of game play of a third example of the Nudge Keno game wherein there is a minimum match between the ten player selected numbers and the twenty numbers randomly selected by the game computer, and the player receives nudge options due to a match between some of the five additional nudge numbers randomly selected by the game computer and the twenty numbers randomly selected by the game computer;

FIG. 6 shows the second step of game play of the third example of the Nudge Keno game wherein the player exercises their nudge options but doesn't increase the number of winning number matches, but receives increased winnings due to having the nudge options;

FIG. 7 shows the first step of game play of a fourth example of the Nudge Keno game wherein there is a minimum match between the ten player selected numbers and the twenty numbers randomly selected by the game computer, and the player receives nudge options due to a match between some of the five additional nudge numbers randomly selected by the game computer and the twenty numbers randomly selected by the game computer;

FIG. 8 shows the second step of game play of the fourth example of the Nudge Keno game wherein the player exercises their nudge options and thereby increases their winning number matches, and receives increased winnings due to both the increased winning number matches and having nudge options;

FIG. 9 shows a functional block diagram of the steps involved in the software program used to implement Nudge Keno; and

FIG. 10 shows a general block diagram of the video gaming system used to implement the game computer controlled video implementation of the Nudge Keno game.

### DETAILED DESCRIPTION

The present invention combines the most desirable features of existing Keno games with a novel improvement that gives a player more sense of participation and control, the opportunity to make decisions, reasonable odds of winning, and what the players perceive is a chance to beat odds that are normally in favor of a casino. The result is a more desirable Keno games called “Nudge Keno” and is played on a video gaming machine equipped to provide touch screen operation. The use of touch screen technology with gaming machines is well known in the video gaming art. As specific locations on a video screen are touched during game play the touch is sensed by a game computer and appropriate game action is taken as is described hereinafter.

The improvement is achieved with a standard Keno game in which a player selects up to ten numbers from a total of eighty numbers (1-80) and the game computer randomly selects twenty numbers from the same eighty numbers. The game computer then randomly selects five additional “nudge numbers” from the eighty numbers in accordance with the teaching of the invention. The computer compares the twenty randomly selected numbers with the player selected numbers. If there are a predetermined number of matches between these two sets of numbers the player will have some winnings in a manner known in the prior art.

In addition, if there are a minimum number of matches between the five additional nudge numbers randomly selected by the computer and the twenty numbers randomly initially selected by the computer the player receives options to have additional numbers randomly selected and added to the twenty randomly selected numbers for the purpose of determining winning number matches with the player selected numbers. The number of options the player receives depends on the number of matches between the twenty randomly drawn numbers and the randomly drawn five nudge numbers, and if all five nudge numbers match the player receives options to have five additional numbers randomly selected. This increases the chances of how much the player may win since there are more numbers to compare to the player selected numbers. If there are additional matches with the additional randomly selected numbers the player's winnings are increased. In addition the player's winnings are determined on a different portion of the pay table for the game in which the winnings are multiplied.

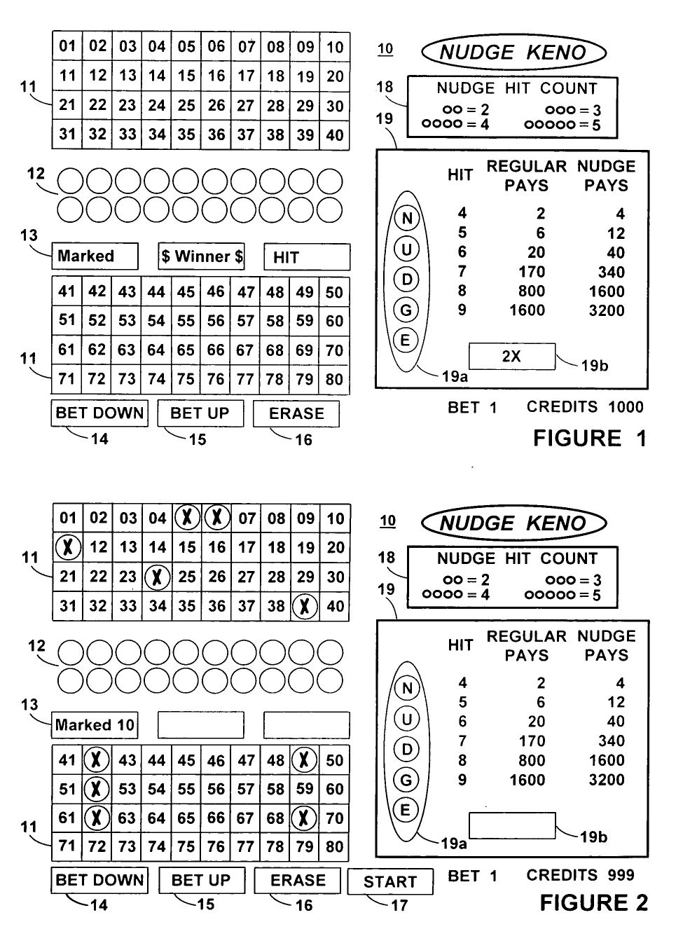

In FIG. 1 is shown the display screen of a video Keno game having additional display elements for implementing the novel Nudge Keno game. Alike prior art video Keno games there is an 8×10 matrix 11 of numbers from 1 to 80 (hereinafter called the “8×10 matrix 11” from which a player selects up to ten numbers to be played during a round of game play. The numbers are selected by the player touching the display screen at the location of selected numbers. Player selected play number are marked by an “X” as shown in and described with reference to FIG. 2. There is also a field 12 of twenty positions (hereinafter called the “20 display 12” in which are displayed the twenty numbers randomly selected by the game computer for Keno game play.

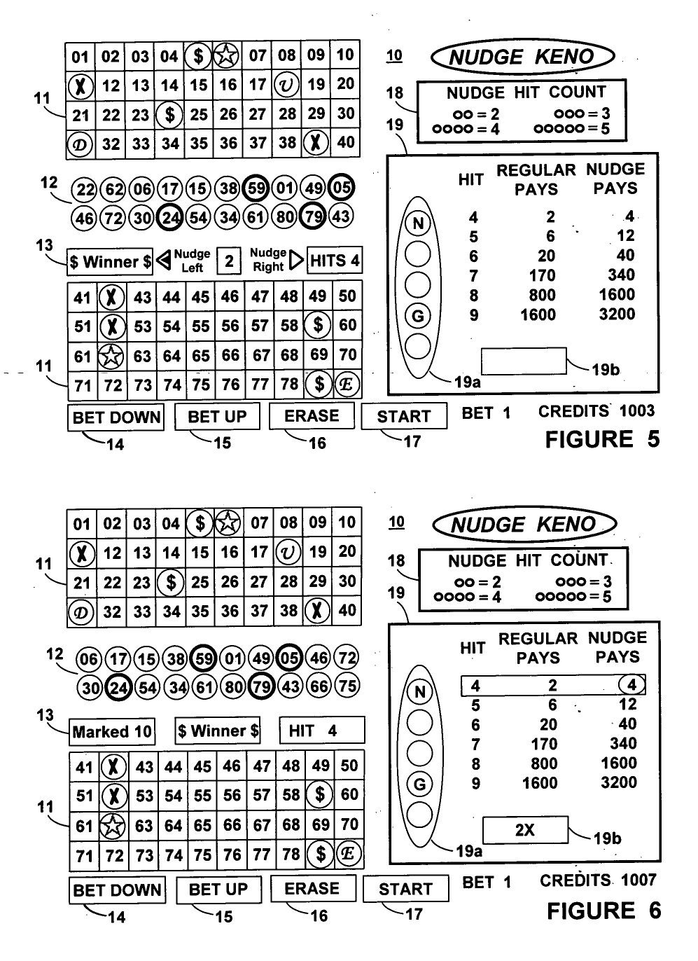

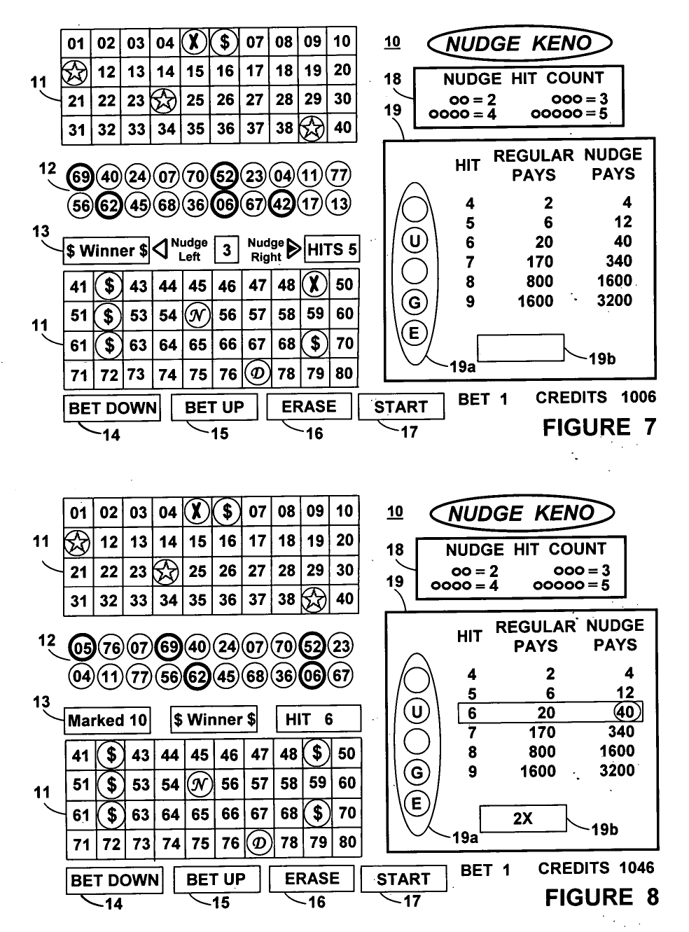

There is a row of blocks 13 in which are indicated various things. The first block is entitled “Marked” and indicates the plurality of between one and ten numbers a player selects for Keno game play. If a player selects ten numbers to be played that block will appear as “Marked 10” as shown in FIGS. 2 through 8. There is a second block entitled “Hit” which indicates the number of matches between the up to ten player selected numbers and the twenty numbers randomly selected by the computer and any additional matches obtained as a result of a player exercising nudge options. There is also a third block entitled “$Winner$” that indicates when a player is a winner at a round of Nudge Keno game play. The display in the row of blocks 13 may change during game play as maybe seen in FIGS. 5 and 7 and this is described hereinafter with reference to those figures.

To place bets the player touches “Bet Up” button 15 once for each bet they wish to place up to some maximum number of bets. In the four examples of Nudge Keno described herein only a single bet is placed on each game as indicated by the “Bet 1” displayed below box/area 19. If the player wishes to decrease their number of bets they may touch “Bet Down” button 14 once for each reduction in the number of bets they wish to place on a round of Nudge Keno game play. Keno games generally have a Bet Max button (not shown) which a player may touch to place quickly some maximum number of bets. This button is not shown in the figures to keep the drawings as simple as possible and uncluttered.

After a player has selected up to ten numbers to play in a round of Nudge Keno game play from the numbers displayed in 8×10 matrix 11, if they wish to reselect the numbers, they touch “Erase” button 16. All “X”s displayed in 8×10 matrix 11 disappear and the player may select different numbers to play by touching them on the matrix. Buttons that are touched have an “X” displayed therein, rather than a number, as may be seen in FIGS. 2-8. In between rounds of Keno game play the player may wish to change their player selected numbers for the next round of game play. They will utilize Erase button 17 for this purpose.

Below block or area 19 is provided an indication of the number of bets that a player is placing on a round of Nudge Keno game play. Also displayed at this location is the number of credits that a player has to play. The value “CREDITS 1000” is shown as the player's starting credits in FIG. 1. That number is decremented by the number of bets that a player places on each round of Nudge Keno game play, and is incremented by any winnings that a player receives. Increases and decreases in this number according to bets placed and winnings are shown in and described with reference to FIGS. 2-8.

In block or area 19 there is a pay table having two columns entitled “Hit” and “Regular Plays”. When a player wins a round of game play without receiving and exercising any nudge options their winnings are determined solely by the number of matches between the ten player selected numbers and the twenty numbers randomly selected by the computer. This payout is known in the prior art. For example, if a player has six matches between the numbers they select and the twenty numbers randomly selected by the computer and displayed in 20x area 12 while having no nudge number matches, per the payout table the player wins 20 credits.

In area 19 the payout table also has a column named “Nudge Pays” with a set of numbers therein. If a player has at least four matches between the numbers they select to play and the twenty numbers randomly selected by the computer, and has at least two matches between the five computer selected nudge numbers and the twenty numbers randomly selected by the computer, their payout is determined by the “Nudge Pays” column rather than the “Regular Pays” column. For example, when a player has six matches between the numbers they select and the twenty numbers randomly selected by the computer and displayed in 20x area 12 while having at least two nudge number matches, per the payout table the player wins 40 credits. This is double the winnings described in the previous paragraph and is also indicated by the display “2X” near the bottom of area 19.

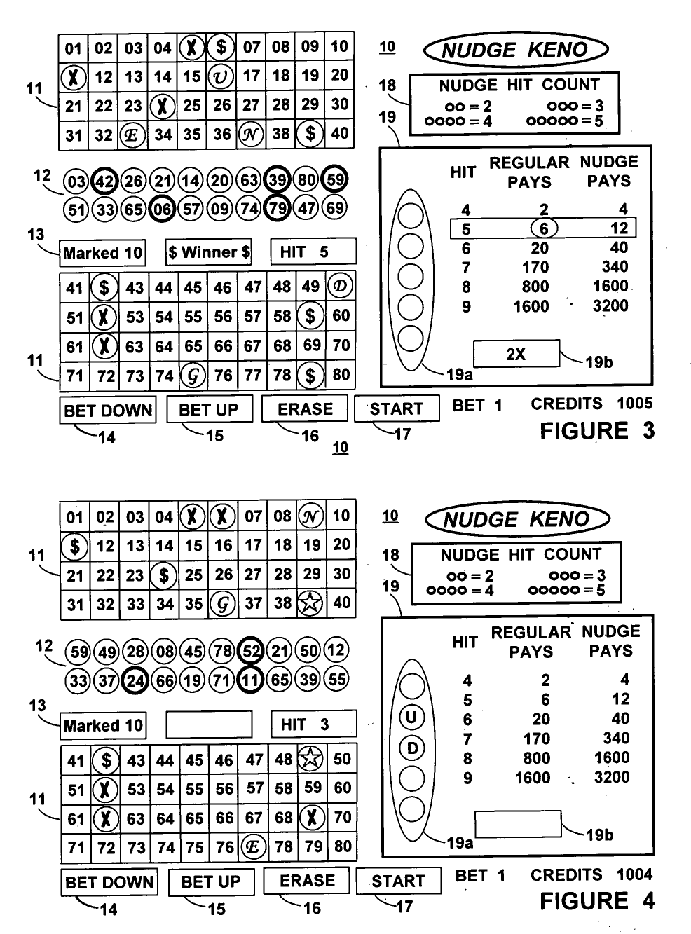

To the left side of area 19 is an oval 19a in which are the capital letters NUDGE, with each letter being in a circle. When the computer randomly selects the twenty numbers that are displayed in 20x area 12 as shown in FIGS. 3-8, the computer also randomly selects five additional numbers (“nudge numbers”)—one associated with each of the five letters spelling the word NUDGE. When there is a match between some of the randomly selected nudge numbers and the twenty numbers that are displayed in 20x area 12, the letters associated with those numbers are displayed in the associated one of the five circles in oval 19a such as shown in FIG. 4. In addition, the nudge number matches are displayed in 8×10 matrix 11 as is described further in this description.

Some standard features of a Keno video game that are well known in the prior art are deliberately not shown in FIG. 1 and the other figures to avoid detracting from the teaching of the present invention and to avoid cluttering the drawing. Typically there is a slot for inserting coins or tokens for placing a number of wagers or bets for a round of game play. In addition, there may be a slot for the insertion of a debit card from which the game debits the number of wagers or bets placed by a player, and to which the game credits any winnings. Also, if there is a slot for insertion of coins or tokens there will be a tray into which winnings in the form of coins or tokens are dispensed. The video screen display may include information such as, but not limited to, Max Bet, copyright and trademark notices, manufacturer of equipment, name of game, and fancy graphics.

In FIG. 2 is shown the same display screen as shown in FIG. 1 with ten numbers selected by a player to be played in the Nudge Keno game. The numbers are 05, 06, 11, 24, 39, 42, 49, 52, 62 and 69 in the 8×10 matrix 11 and the numbers are highlighted by replacing each of them with an “X”. These ten player selected numbers are used in the four examples of the Nudge Keno game described with reference to FIGS. 3 through 8.

The player has also placed one bet on the game by touching Bet Up button 15 once, and this bet is indicated below area 19 as “BET=1”. The player having bet “1” credit, their credit total displayed below area 19 is decremented by “1” to read “CREDIT 999”. In FIG. 1 the player's starting credit total reads “CREDITS 1000”.

After a player selects up to ten numbers to play, as shown by the “X”s in 8×10 matrix 11, and has placed a bet, Start button 17 appears on the screen. When the player touches Start button 17 the game play continues as described with the four game examples shown in and described with reference to FIGS. 3-8.

In FIG. 3 is shown a first example of Nudge Keno game play wherein the player receives winnings due to a minimum number of matches between the ten player selected numbers and the twenty numbers randomly selected by the computer in a conventional manner. There are no matches between the five additional nudge numbers randomly selected by the computer and the twenty numbers randomly selected by the computer.

As indicated with reference to FIG. 2, the player has selected the ten numbers 05, 06, 11, 24, 39, 42, 49, 52, 62 and 69 in 8×10 matrix 11 to play and the numbers are highlighted by replacing each of them with an “X”. In row 13 the first block reads “Marked 10” indicating that the player has selected ten numbers to play. Although not described herein a player may select fewer than ten numbers to play. If fewer numbers are selected by the player to be played, the pay table changes.

In addition, at the start of game play the game computer has randomly selected five additional nudge numbers as very briefly described above. Those numbers are also displayed in 8×10 matrix 11. For this first example of the Nudge Keno game the nudge numbers are 37, 16, 50, 75 and 33 and the letters N, U, D, G and E are displayed in the corresponding number boxes as shown.

As part of standard Keno game play the computer randomly selects the twenty numbers shown in 20x area 12. Those numbers are, in the order they are randomly selected, 03, 42, 26, 21, 14, 20, 63, 39, 80, 59, 51, 33, 65, 06, 57, 09, 74, 79, 47 and 69. The game computer then compares the ten player selected numbers with the twenty randomly selected numbers displayed in area 12 for number matches. In this first game example there are five numbers matches—42, 39, 59, 06 and 79. These numbers are actually highlighted to a player of a video gaming machine in a number of ways but with restriction of the drawing they are shown in bolded circles. There being at least four number matches the player knows they have some winnings and this indicated in area 13 by the display of “$WINNER$”. In addition, the number of number matches is shown in area 13 as “HIT 5”.

The game computer also compares the five randomly selected nudge numbers, identified by the letters NUDGE in 8×10 matrix 11 with the twenty numbers randomly selected by the game computer and shown in 20x area 12. In this first example of Nudge Keno game play there are no nudge number matches so ones of the letters of the word NUDGE do not appear in the circles in oval 19a in area 19. Accordingly, the player receives no nudge options and thereby has no additional numbers randomly selected and displayed in 20x area 12 to increase the odds of winning. As a result, the player's winning are not multiplied but are only determined from the “Regular Pays” column in the pay table in area 19. In this first example of Nudge Keno game play, with their being five number matches and no nudge number matches, per the pay table in area 19 the player has won 6 credits. These winnings are reflected below area 19 as “CREDITS 1005”. The player bet one credit decrementing their total to 999 and won 6 credits incrementing their credit total to 1005.

In FIG. 4 is shown a second example of Nudge Keno game play wherein the player receives no winnings because there is no minimum match between the ten player selected numbers and the twenty numbers randomly selected by the computer, although there is a match between two of the five additional nudge numbers randomly selected by the computer and the twenty numbers randomly selected by the computer.

At the start of play the player bets one credit, decrementing their credit total to 1004, and elects to play the same ten numbers they selected to play in FIG. 2. Accordingly, the player does not utilize Erase button 16 to erase their prior selection of numbers and re-choose a new set of up to ten numbers. After the player touches the now displayed Start button 17 the game computer randomly selects twenty numbers, from the base of eighty numbers (1-80), and displays them in 20x area 12. Those twenty numbers are 59, 49, 28, 08, 45, 78, 52, 21, 50, 12, 33, 37, 24, 66, 19, 71, 11, 65, 39 and 55. In accordance with the teaching of the invention the game computer also randomly selects five additional nudge numbers. The nudge numbers are 09, 39, 49, 36 and 77 and the associated ones of the letters NUDGE are displayed in the corresponding blocks in 8×10 matrix 11 as shown.

The game computer compares the ten player selected number with the twenty numbers in 20x area 12 for matches. In this second game example there are only three number matches—11, 24 and 52. These numbers are highlighted to the player as bolded circles. In addition, the number of number matches is shown in area 13 as “HIT 3”. There being less than four number matches, per the rules of the game the player receives no game winnings and any nudge number matches are not considered.

There are nudge number matches for the numbers 39 and 49. All nudge number matches are indicated by Stars displayed in the appropriate positions in 8×10 matrix 11 and are displayed in number positions 39 and 49 accordingly. Although the minimum number of nudge number matches required to get options for additional randomly selected numbers in 20x area 12 is two, because the player does not have the minimum of four matches between player selected numbers and the computer selected numbers they do not receive the nudge options.

In FIGS. 5 and 6 are shown a third example of Nudge Keno game play. FIG. 5 shows the first step of game play wherein there is a minimum match of four between the ten player selected numbers and the twenty numbers randomly selected by the game computer. In addition the player receives two nudge options due to there being the minimum two matches between the five additional nudge numbers randomly selected by the computer and the twenty numbers randomly selected by the computer, while at the same time there are the four matches described above per the game rules. FIG. 6 shows the second step of game play wherein the player exercises their nudge options in an attempt to increase their winnings.

At the start of Nudge Keno game play for the third example the player bets one credit, decrementing their credit total to 1003, and elects to play the same ten numbers selected in FIG. 2. Accordingly, the player does not utilize Erase button 16 to erase their prior selection of numbers and re-choose a new set of up to ten numbers. After the player touches the now displayed Start button 17 the game computer randomly selects the twenty numbers, from the base of eighty numbers (1-80), displayed in 20x area 12. Those numbers are 22, 62, 06, 17, 15, 38, 59, 01, 49, 05, 46, 72, 30, 24, 54, 34, 61, 80, 79 and 43. In accordance with the teaching of the invention the game computer also randomly selects five additional nudge numbers. The nudge numbers are 06, 18, 31, 62 and 80 and the associated ones of the letters NUDGE are displayed in the corresponding positions in 8×10 matrix 11 as shown. When there is a match between a nudge number and one of the numbers in the 20x area 12 the number in the matrix changes to a Star. In FIG. 5 such matches exist and number blocks 06 and 62 have stars displayed therein.

The game computer then compares the ten player selected numbers with the twenty numbers in 20x area 12 for matches. In this third game example there are four number matches—59, 05, 24 and 79. These numbers are highlighted to the player as bolded circles in 20x area 12 as shown. In addition, the quantity of number matches is shown in area 13 as “HIT 4”. There being at least four number matches the player will receive some game winnings and any nudge number matches will be considered.

There are nudge number matches for the numbers 06 and 62. All nudge number matches are indicated by Stars displayed in the appropriate positions in 8×10 matrix 11 and are displayed in number positions 06 and 62 accordingly. Because the minimum number two of nudge number matches required to get options for additional randomly selected numbers in 20x area 12 has been reached, the player receives two nudge options. If the player had three nudge number matches they would receive three nudge options, if they had four nudge number matches they would receive four nudge options, and if they had the maximum of five nudge number matches they would receive the maximum of five nudge options.

Display area 13 changes accordingly, as shown in FIG. 5, to indicate to the player that they have game winnings by the display of $WINNER$. In addition the nudge options are displayed indicating the fact to the player. In area 13 there is now a small box with the number 2 therein indicating to the player that they have received two nudge options. To either side of this small box is an arrow with the arrow on the left being designated “Nudge Left” and the arrow on the right being designated “Nudge Right”. Each time the player exercises a nudge option they touch one of these two arrows. When the player touches Nudge Right all the twenty numbers randomly selected by the computer and displayed in 20x area 12 shift to the right one position, with the furthest right number disappearing from area 12 and the a new randomly selected number appearing at the left end of area 12. If a match number in a darkened circle, such as number 79 in this third example of Nudge Keno, is nudged off one end or the other end of the twenty positions in 20x display 12, it is not lost. The player still has the number match in their match total for determining winnings.

In FIG. 6 the player exercises their nudge options in an attempt to increase their winnings. In this third example of Nudge Keno the player decides to exercise their two nudge options by touching the Nudge Left arrow twice. It can be seen in 20x area 12 in FIG. 6 that all numbers have been shifted to the left two places. In the process the numbers 22 and 62 at the left end in FIG. 5 are lost and two new numbers, 66 and 75 appear at the right end as shown in FIG. 6.

No new number matches are created by exercising the nudge option so the player doesn't increase their number of winning number matches beyond the four matches. However, since the player had received nudge options their winnings are determined by a different pay table, the “Nudge Pays” pay table in area 19, wherein the winnings are twice that of the “Regular Wins” pay table. The doubled winnings are reflected by the “2X” displayed in block 19b in area 19. For this third example of Nudge Keno game play, as shown in area 19 the player has won 4 credits instead of 2 credits. Accordingly, the player's credit total is incremented from 1003 credits in FIG. 5 to 1007 credits in FIG. 6.

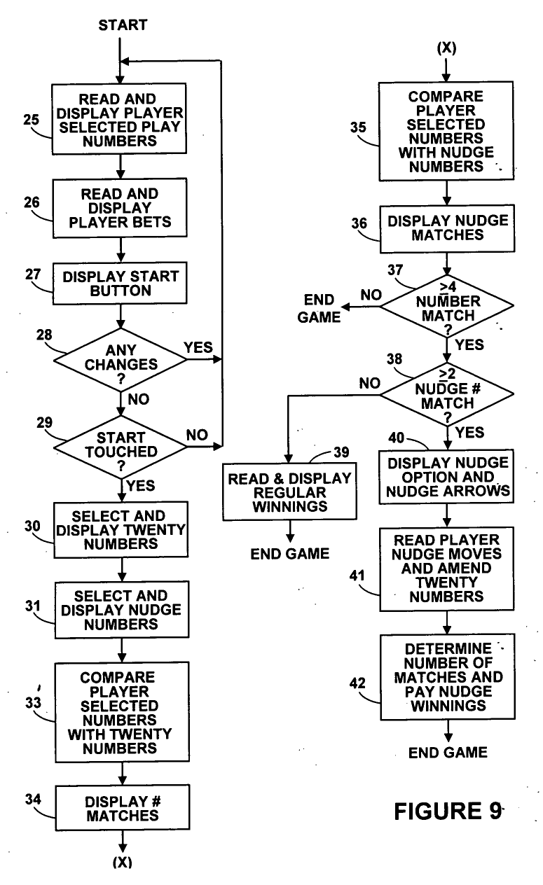

In FIGS. 7 and 8 are shown a fourth example of Nudge Keno game play. FIG. 7 shows the first step of game play wherein there are five matches between the ten player selected numbers and the twenty numbers randomly selected by the computer, and the player receives three nudge options due to a match of three of the five additional nudge numbers randomly selected by the computer and the twenty numbers randomly selected by the computer. In the exercise of the three nudge options there is an additional number match 05 with the player selected numbers and the player increases their winnings by changing from 5 hits to 6 hits.

At the start of game play the player bets one credit, decrementing their credit total to 1006, and elects to play the same ten numbers selected to be played in FIG. 2. Accordingly, the player does not utilize Erase button 16 to erase their prior selection of numbers and re-choose a new set of up to ten numbers using buttons 14 and 15. After the player touches the now displayed Start button 17 the game computer randomly selects the twenty numbers from the base of eighty numbers (1-80) displayed in 20x area 12. Those numbers are 69, 40, 24, 07, 70, 52, 23, 04, 11, 77, 56, 62, 45, 68, 36, 06, 67, 42, 17 and 13. In accordance with the teaching of the invention the game computer also randomly selects five additional nudge numbers. The nudge numbers are 55, 11, 77, 39 and 24 and the associated ones of the letters NUDGE are displayed in the corresponding blocks in 8×10 matrix 11 as shown. When there is a match between a nudge number and one of the numbers in the 20x area 12 the corresponding number in matrix 11 changes to a star. In FIG. 7 such matches exist and number blocks 11, 24 and 39 have Stars displayed therein.

The game computer compares the ten player selected numbers with the twenty numbers randomly selected and displayed in 20x area 12 for matches. In this fourth game example there are five number matches 69, 52, 62, 06 and 42. These numbers are highlighted to the player in area 12 as bolded circles as shown. In addition, the number of number matches is shown in area 13 as “HIT 5”. There being at least four such number matches the player will receive game winnings apart from any additional winnings flowing from nudge number matches.

There are nudge number matches for the numbers 11, 24 and 39. Thus, the letters U, G and E are displayed in oval 19a in area 19. All nudge number matches are indicated by a Star displayed in the appropriate positions in 8×10 matrix 11 and are displayed in number positions 11, 24 and 39 accordingly. Because the minimum number (two) of nudge number matches required to receive nudge options for additional randomly selected numbers in 20x area 12 has been exceeded, the player receives three nudge options.

Display area 20 changes accordingly, as shown in FIG. 7, to indicate to the player that they have game winnings by the display of $WINNER$. In addition the nudge options are displayed. In area 20 there is now a small box with the number 3 therein indicating to the player that they have received three nudge options. To either side of this small box is an arrow button with the arrow button on the left being designated “Nudge Left” and the arrow button on the right being designated “Nudge Right”. Each time the player exercises a nudge option they touch one of these two arrow buttons. Each time the player touches the Nudge Right button all the twenty numbers randomly selected by the computer and displayed in 20x area 12 shift to the right one position, with the furthest right number disappearing from area 12 and a new randomly selected number appearing at the left end of area 12. If a match number in a bolded circle, such as number 69 in this fourth example of Nudge Keno, is nudged off one end or the other end of the twenty positions in 20x display 12, it is not lost. The player still has the number match or hit in their hit total for determining winnings.

In FIG. 8 the player exercises their nudge options in an attempt to increase their winnings. In this fourth example of Nudge Keno the player decides to exercise their three nudge options by touching the Nudge Right arrow three times. It can be seen in 20x area 12 in FIG. 8 that all numbers have been shifted to the right three places. In the process the numbers 42, 17 and 13 at the right end of 20x area 12 in FIG. 7 are lost and three new randomly selected numbers 05, 76 and 07 appear at the left end as shown in FIG. 8. The hit count of 5 that included the number 42 is not decremented even though the number 42 is shifted off the right end of area 12 as the three Nudge Right options are executed.

The new number 05 randomly selected by exercising the three Nudge Right options matches one of the ten player selected numbers so the player now has six matches or hits and their earnings are thereby increased. The player's nudge options are determined by the “Nudge Pays” pay table wherein the winnings are twice that of the “Regular Wins” pay table. The doubled winnings are reflected by the “2k X” displayed in block 19b in area 19. For this fourth example of Nudge Keno game play, as shown in area 19, the player has won 40 credits. Accordingly, the player's credit total is incremented from 1006 credits in FIG. 5 to 1046 credits in FIG. 8.

In the four examples of Nudge Keno game play described herein all nudge options are always exercised. If in the event that it is provided that a player need not exercise any nudge options, although that is unlikely, a Stop or End button may be added to the video display for the player to indicate to the computer when they have finished exercising less than all their nudge options.

In FIG. 9 is shown a functional block diagram of the steps involved in the software program used to implement Nudge Keno. The game starts at block 25 waiting for a player touch one of the eighty number positions in 8×10 matrix 11 (1-80) indicating the up to ten player selected numbers they wish to play. As the player touches these numbers their selections are detected and are marked with an “X” as described with reference to FIG. 2. At block 26 the game watches for the player to touch Bet Up button 15 and Bet Down button 14 to place a bet of 1 or more on a round of game play. As the player does this the number of bets placed are displayed under area 19 as seen in FIGS. 2-8.

After player selected numbers have been picked and a bet placed, at block 27 the game software displays Start button 17. At decision block 28 the software periodically determines if the player has touched any of the on-screen buttons indicating changes have been made to the player selected numbers or the player bet. If the decision is Yes, the program cycles back to block 25 to check for any changes in the player selected numbers and the amount of the player's bet. For example, the player may have touched Erase button 17 deleting all their player selected numbers and is then going to enter a new set of player selected numbers.

At decision block 29 the game software periodically determines if the player has touched Start button 17 indicating the continuation of game play. As long as the software does not detect that Start button 17 has been touched, the game exits block 29 at No and cycles back to the input of block 25 to continue watching for any changes in the player selected number and changes to the player's bet. Eventually the player will complete their selection of numbers to play and their bet and will touch Start button 17. The program then exits block 29 at Yes and progresses to block 30.

At block 30 the game program randomly selects twenty numbers that are displayed in 20x area 12 as previously described with reference to FIG. 2. At block 31 the game program also randomly selects the five nudge numbers as previously described. The nudge numbers are displayed by showing the letters of NUDGE in number positions of the 8×10 matrix 11 as previously described.

At block 33 the program compares the twenty randomly selected numbers in 20x area 12 with the player selected numbers displayed in 8×10 matrix 11 with Xs and when there are matches the X is changed to a $ on the selected number position in matrix 11.

At block 34 the matches from the number comparison performed in block 33 are displayed. In FIGS. 3-8 this is bolding the circle around matching ones of the numbers in 20x area 12. The program exits block 34 at (X) and continues to block 35 where the program compares the twenty randomly selected numbers with the additional five randomly selected nudge numbers picked and displayed at block 31. At block 36 the program displays any matched nudge numbers in matrix 11 by replacing appropriate ones of the letters NUDGE with a Star as previously described.

At decision block 37 the game program determines if there are a minimum number of matches between the player selected numbers and the twenty randomly selected numbers shown in 20x matrix 12. When the player has selected ten numbers the minimum number is four, the number used for the four examples of Nudge Keno shown in and described with reference to FIGS. 3-8. If the decision is Yes the program progresses to decision block 38. If the decision is No, the program exits block 37 at No and ends the round of game play of Nudge Keno. The player has no winnings. There must be the minimum of four matches for the game to continue and have any winnings.

Entering decision block 38 it has already been determined that there is the minimum of four matches between the ten player selected numbers and the twenty randomly selected numbers. At block 38 it is determined if there are at least two matches between the five randomly selected nudge numbers and the twenty randomly selected numbers.

If there are not at least two matches there can be no nudge options granted to the player and no winnings based on the “Nudge Pays” pay table in area 19 of FIGS. 3-8. If there are not four number matches the program exits block 38 at No and progresses to block 39 where the player's winnings are determined from the “Regular Pays” column of the pay table in area 19 of FIGS. 3-8 and the winnings are paid to the player. The round of game play of Nudge Keno is over.

However, if there are a minimum of two matches between the nudge numbers and the twenty randomly selected numbers displayed in 20x area 12 the program exits block 38 at Yes and progresses to block 40 where the player is granted nudge options that are displayed as the nudge arrows and number in the middle of area 13 as shown in FIGS. 5 and 7.

The program progresses to block 41 where the player touching the nudge arrows to exercise their nudge options is sensed and new randomly numbers are displayed in 20x area 12 as previously described. Also as previously described the number of nudge -options a player receives equals the number of matches between the initial randomly selected twenty numbers and the randomly selected nudge numbers.

When all nudge options have been exercised and the indicated nudges performed in 20x area 12 the program progresses to block 42 where it is determined if there are any additional matches or hits between the player selected numbers and the new numbers displayed as a result of exercising the nudge options. The final number of matches or hits are then used to pay the player their winnings using the “Nudge Pays” pay table in area 19 in FIGS. 3-8. At this point the game is over and is ended.

The program then reverts back to Start at the input of block 25 to await a player to play another round of Nudge Keno game play.

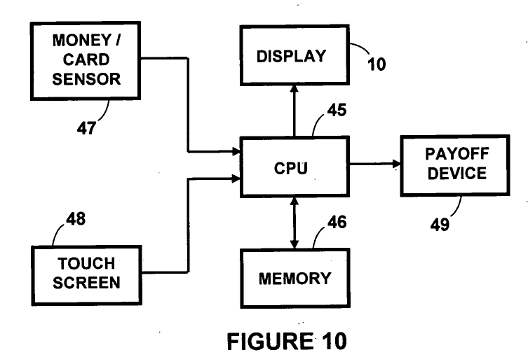

In FIG. 10 is shown a general block diagram of the electronic hardware used to implement a computer controlled implementation of the Nudge Keno video game incorporating the teaching of the present invention. The heart of the computer controlled slot machine is a central processor unit (CPU) 45 running the Nudge Keno program that is stored in memory 46. The basic operations of a Keno Game are well known in the art and are not repeated here for the sake of brevity. Responsive to the Nudge Keno game program CPU 45 causes a display on display 10, such as shown in FIGS. 1-8. Coupled with display 10 is touch screen 48 apparatus that is well known in the art and indicates to CPU 45 when and where a player has touched ones of the on-screen buttons displayed on display 10 as previously described.

The Nudge Keno video game may have a slot for inserting coins or tokens for placing a number of wagers or bets for each round of game play. Alternatively, there may be a slot for the insertion of a debit card from which CPU 45 debits the number of credits or bets placed by a player, and to which CPU 45 credits any winnings. These monetary functions are shown at the box entitled Money/Card Sensor 47 which is connected to CPU 45 to receive indications of coin or token insertions, and to read and write a debit card under control of CPU 45. Also, when there is a slot for insertion of coins or tokens there will be a tray into which winnings in the form of coins or tokens are dispensed. This tray is shown as Payoff Device 49 which is controlled by CPU 45 to dispense winnings in the form of coins or tokens.

Using touch screen 48 CPU 45 monitors a player touching on-screen buttons described with reference to FIGS. 1-8 and responds accordingly to implement game functions as previously described.

While what has been described hereinabove are several examples of Nudge Keno game play per the preferred embodiment of the invention, it should be understood that numerous changes maybe made without departing from the spirit and scope of the invention.

1. A method for playing a computer controlled video Keno game wherein a player places a bet and selects a first set of numbers to be played, the method comprising the steps of:
(a) randomly selecting a second set of numbers greater in quantity than the first set of player selected numbers;
(b) randomly selecting a third set of numbers;
(c) comparing the first and second sets of numbers for matches and if there are more than a first predetermined number of matches between the first and second sets of numbers the player has game winnings per a first pay table;
(d) comparing the first and third sets of numbers and if there are more than a second predetermined number of matches between the first and third sets of numbers the player has additional numbers added to the second set of numbers; and
(e) comparing the additional numbers to the first set of numbers to determine if there are additional matches that may result in the player receiving increased game winnings.

2. The method for playing a computer controlled video Keno game in accordance with claim 1 wherein when there are more than the second predetermined number of matches between the first and third sets of numbers in step (d) the game winnings are determined from a second pay table that provides greater game winnings than the first pay table.

3. The method for playing a computer controlled video Keno game in accordance with claim 2 wherein there must be more than the first predetermined number of matches between the first and second sets of numbers before there can be game winnings by having more than the second predetermined number of matches between the first and third sets of numbers.

4. The method for playing a computer controlled video Keno game in accordance with claim 3 wherein when there are more than the second predetermined number of matches between the first and third sets of numbers in step (d) the number of additional numbers added to the second set of numbers is equal to the number of matches between the first and third number sets.

5. The method for playing a computer controlled video Keno game in accordance with claim 4 wherein in step (d) when there are more than a second predetermined number of matches between the first and third sets of numbers the player has the option of receiving the additional numbers.

6. The method for playing a computer controlled video Keno game in accordance with claim 5 wherein the additional numbers are randomly chosen.

7. The method for playing a computer controlled video Keno game in accordance with claim 16 further comprising the steps of:
(f) displaying the randomly chosen second number set determined in step (a);
(g) displaying the randomly chosen third number set determined in step (b);
(h) displaying all matches between the first and second number sets determined in step (c); and
(i) displaying all matches between the first and third numbers sets determined in step (d).

8. The method for playing a computer controlled video Keno game in accordance with claim 1 wherein in step (d) when there are more than a second predetermined number of matches between the first and third sets of numbers the player has the option of receiving the additional numbers.

9. The method for playing a computer controlled video Keno game in accordance with claim 8 wherein when there are more than the second predetermined number of matches between the first and third sets of numbers in step (d) and there are less than the first predetermined number of matches between the first and second sets of numbers the player has no game winnings.

10. The method for playing a computer controlled video Keno game in accordance with claim 9 wherein when there are more than the second predetermined number of matches between the first and third sets of numbers in step (d) the game winnings are determined from a second pay table that provides greater game winnings than the first pay table.

11. The method for playing a computer controlled video Keno game in accordance with claim 10 wherein the additional numbers are randomly chosen.

12. The method for playing a computer controlled video Keno game in accordance with claim 16 further comprising the steps of:
(f) displaying the randomly chosen second number set determined in step (a);
(g) displaying the randomly chosen third number set determined in step (b);
(h) displaying all matches between the first and second number sets determined in step (c); and
(i) displaying all matches between the first and third numbers sets determined in step (d).

13. The method for playing a computer controlled video Keno game in accordance with claim 1 wherein there must be more than the first predetermined number of matches between the first and second sets of numbers before there can be game winnings by having more than the second predetermined number of matches between the first and third sets of numbers.

14. The method for playing a computer controlled video Keno game in accordance with claim 13 wherein when there are more than the second predetermined number of matches between the first and third sets of numbers in step (d) the number of additional numbers added to the second set of numbers is equal to the number of matches between the first and third number sets.

15. The method for playing a computer controlled video Keno game in accordance with claim 14 wherein the additional numbers are randomly chosen.

16. The method for playing a computer controlled video Keno game in accordance with claim 16 further comprising the steps of:
(f) displaying the randomly chosen second number set determined in step (a);
(g) displaying the randomly chosen third number set determined in step (b);
(h) displaying all matches between the first and second number sets determined in step (c); and
(i) displaying all matches between the first and third numbers sets determined in step (d).

17. A computer readable medium containing computer executable instructions for playing a computer controlled video Keno game wherein a player places a bet and selects a first set of numbers to be played, the executable program instructions comprising instructions for:
(a) the computer randomly selects a second set of numbers greater in quantity than the first set of player selected numbers;
(b) the computer randomly selects a third set of numbers that is smaller in quantity than the first set of numbers;
(c) comparing the first and second sets of numbers for matches and if there are more than a first predetermined number of matches between the first and second sets of numbers the player has game winnings per a first pay table;
(d) comparing the first and third sets of numbers and if there are more than a second predetermined number of matches between the first and third sets of numbers, while there are the first predetermined number of matches between the first and second sets of numbers, the player receives options to have randomly selected additional numbers added to the second set of numbers; and
(e) comparing the additional numbers to the first set of numbers to determine if there are additional matches that may result in the player receiving increased game winnings.

18. The method for playing a computer controlled video Keno game in accordance with claim 17 wherein when there are more than the second predetermined number of matches between the first and third sets of numbers in step (d) the number of additional numbers added to the second set of numbers is equal to the number of matches between the first and third number sets.

19. The method for playing a computer controlled video Keno game in accordance with claim 18 wherein when there are more than the second predetermined number of matches between the first and third sets of numbers in step (d) the game winnings are determined from a second pay table that provides greater game winnings than the first pay table.

20. The method for playing a computer controlled video Keno game in accordance with claim 19 further comprising the steps of:
(f) displaying the randomly chosen second number set determined in step (a);
(g) displaying the randomly chosen third number set determined in step (b);
(h) displaying all matches between the first and second number sets determined in step (c); and
(i) displaying all matches between the first and third numbers sets determined in step (d).
